(19) United States
(12) Patent Application Publication
(10) Pub. No.: US 2018/0075368 A1
(43) Pub. Date: Mar. 15, 2018

(54) System and Method of Advising Human Verification of Often-Confused Class Predictions

(71) Applicant: International Business Machines Corporation, Armonk, NY (US)

(72) Inventors: Paul E. Brennan, Dublin (IE); Scott R. Carrier, Apex, NC (US); Michael L. Stickler, Columbus, OH (US)

(21) Appl. No.: 15/262,649

(22) Filed: Sep. 12, 2016

(51) Int. Cl. G06N 99/00; G06N 3/00; G06F 17/24; G06F 17/27

(52) U.S. Cl. CPC G06N 99/005; G06N 3/006; G06F 17/2705; G06F 17/2785; G06F 17/241

(57) ABSTRACT

A method, system and a computer program product are provided for classifying elements in a ground truth training set by iteratively assigning machine-annotated training set elements to clusters which are analyzed to identify a prioritized cluster containing one or more elements which are frequently misclassified and display machine-annotated training set elements associated with the first prioritized cluster along with a warning that the first prioritized cluster contains one or more elements which are frequently misclassified to solicit verification or correction feedback from a human subject matter expert (SME) for inclusion in an accepted training set.

### BACKGROUND OF THE INVENTION

In the field of artificially intelligent computer systems capable of answering questions posed in natural language, cognitive question answering (QA) systems (such as the IBM Watson™ artificially intelligent computer system or and other natural language question answering systems) process questions posed in natural language to determine answers and associated confidence scores based on knowledge acquired by the QA system. To train such QA systems, a subject matter expert (SME) presents ground truth data in the form of question-answer-passage (QAP) triplets or answer keys to a machine learning algorithm. Typically derived from fact statements submissions to the QA system, such ground truth data is expensive and difficult to collect. Conventional approaches for developing ground truth (GT) will use an annotator component to identify entities and entity relationships according to a statistical model that is based on ground truth. Such annotator components are created by training a machine-learning annotator with training data and then validating the annotator by evaluating training data with test data and blind data, but such approaches are time-consuming, error-prone, and labor-intensive. Even when the process is expedited by using dictionary and rule-based annotators to pre-annotate the ground truth, SMEs must still review and correct the entity/relation classification instances in the machine-annotated ground truth. With hundreds or thousands of entity/relation instances to review in the machine-annotated ground truth, the accuracy of the SME's validation work can be impaired due to fatigue or sloppiness as the SME skims through too quickly to accurately complete the task. While SME review and validation can be facilitated by automatically clustering and prioritizing the machine-annotated entity/relation instances, such automated processes can be error-prone in situations where there are entity/relation classes with high misclassification rates. As a result, the existing solutions for efficiently and accurately generating and validating ground truth data are extremely difficult at a practical level.

### SUMMARY

Broadly speaking, selected embodiments of the present disclosure provide a ground truth verification system, method, and apparatus for generating ground truth for a machine-learning process by (1) using an annotated ground truth training set to train a first classifier model to identify annotated training set instances (e.g., entities and relationships) which are assigned to clusters characterized by cluster feature vectors, (2) using a confusion matrix of commonly confused or misclassified clusters to derive misclassification features for commonly confused/misclassified clusters, (3) employing the misclassification features for the commonly confused/misclassified clusters to train a second classifier model to detect misclassified training set instances (e.g., false positives) which are characterized by misclassification feature vectors, (4) pairing each misclassification feature vector with a recommended cluster of correctly classified training set instance(s) (e.g., true positives), and (5) flagging any cluster feature vector which aligns with a misclassified feature vector as a probable error for SME verification, including providing a recommended cluster of correctly classified training set instance(s). In selected embodiments, the ground truth verification system may be implemented with a browser-based ground truth verification interface which provides a cluster view of entity and/or relationship mentions from the training set along with a warning for at least one of the annotated training set instances in each entity/relationship cluster which aligns with a misclassified feature vector. In addition or in the alternative, the browser-based ground truth verification interface may be configured to make verification suggestions to a user, such as a subject matter expert, by displaying a reclassification recommendation for at least one of the annotated training set instances in each entity/relationship cluster which aligns with a misclassified feature vector. By presenting clustered verification suggestions, the user can quickly and efficiently identify training examples that can be verified or rejected as a batch. The browser-based ground truth verification interface may also be configured to provide the user with the option to accept, edit or reject individual entity/relationship mentions, to click on a mention to see the entire document, to display a plurality of reclassification recommendations, and/or to leave the training set as is. In this way, information assembled in the browser-based ground truth verification interface may be used by a domain expert or system knowledge expert to verify or correct entity/relationship mentions more quickly, thus expediting the veracity of the ground truth.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a system diagram that includes a QA system connected in a network environment to a computing system that uses a ground truth verification engine to verify, correct, and/or reclassify machine-annotated ground truth data that includes misclassified annotated training sets;

FIG. 2 is a block diagram of a processor and components of an information handling system such as those shown in FIG. 1;

FIG. 3 illustrates a simplified example of a confusion matrix;

FIG. 4 illustrates a simplified flow chart showing the logic for facilitating verification of often-confused entity/relationship instances in clusters of machine-annotated ground truth data for use in training an annotator used by a QA system; and

FIG. 5 illustrates a ground truth verification interface display with a clustered view of entity and/or relationship mentions from annotated ground truth training sets.

### DETAILED DESCRIPTION

The present invention may be a system, a method, and/or a computer program product. In addition, selected aspects of the present invention may take the form of an entirely hardware embodiment, an entirely software embodiment (including firmware, resident software, micro-code, etc.), or an embodiment combining software and/or hardware aspects that may all generally be referred to herein as a “circuit,” “module” or “system.” Furthermore, aspects of the present invention may take the form of computer program product embodied in a computer readable storage medium or media having computer readable program instructions thereon for causing a processor to carry out aspects of the present invention. Thus embodied, the disclosed system, a method, and/or a computer program product is operative to improve the functionality and operation of a cognitive question answering (QA) systems by efficiently providing ground truth data for improved training and evaluation of cognitive QA systems.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a Public Switched Circuit Network (PSTN), a packet-based network, a personal area network (PAN), a local area network (LAN), a wide area network (WAN), a wireless network, or any suitable combination thereof. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language, Hypertext Precursor (PHP), or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a sub-system, module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

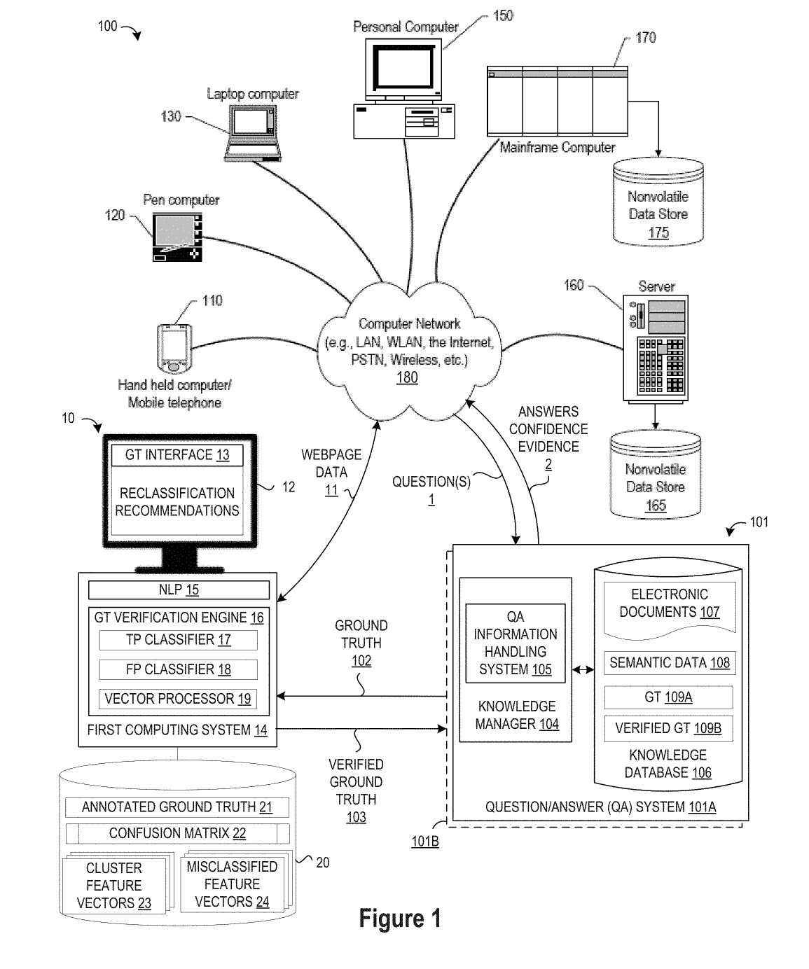

FIG. 1 depicts a schematic diagram 100 of one illustrative embodiment of a question/answer (QA) system 101 directly or indirectly connected to a first computing system 14 that uses a ground truth verification engine 16 to verify, correct, and/or reclassify machine-annotated ground truth data 102 (e.g., entity and relationship instances in training sets) that includes misclassified annotated training sets for training and evaluation of the QA system 101. The QA system 101 may include one or more QA system pipelines 1014, 101B, each of which includes a knowledge manager computing device 104 (comprising one or more processors and one or more memories, and potentially any other computing device elements generally known in the art including buses, storage devices, communication interfaces, and the like) for processing questions received over the network 180 from one or more users at computing devices (e.g., 110, 120, 130). Over the network 180, the computing devices communicate with each other and with other devices or components via one or more wired and/or wireless data communication links, where each communication link may comprise one or more of wires, routers, switches, transmitters, receivers, or the like. In this networked arrangement, the QA system 101 and network 180 may enable question/answer (QA) generation functionality for one or more content users. Other embodiments of QA system 101 may be used with components, systems, sub-systems, and/or devices other than those that are depicted herein.

In the QA system 101, the knowledge manager 104 may be configured to receive inputs from various sources. For example, knowledge manager 104 may receive input from the network 180, one or more knowledge bases or corpora 106 of electronic documents 107, semantic data 108, or other data, content users, and other possible sources of input. In selected embodiments, the knowledge base 106 may include structured, semi-structured, and/or unstructured content in a plurality of documents that are contained in one or more large knowledge databases or corpora. The various computing devices (e.g., 110, 120, 130) on the network 180 may include access points for content creators and content users. Some of the computing devices may include devices for a database storing the corpus of data as the body of information used by the knowledge manager 104 to generate answers to cases. The network 180 may include local network connections and remote connections in various embodiments, such that knowledge manager 104 may operate in environments of any size, including local networks (e.g., LAN) and global networks (e.g., the Internet). Additionally, knowledge manager 104 serves as a front-end system that can make available a variety of knowledge extracted from or represented in documents, network-accessible sources and/or structured data sources. In this manner, some processes populate the knowledge manager which may include input interfaces to receive knowledge requests and respond accordingly.

In one embodiment, the content creator creates content in an electronic document 107 for use as part of a corpora 106 of data with knowledge manager 104. The corpora 106 may include any structured and unstructured documents, including but not limited to any file, text, article, or source of data (e.g., scholarly articles, dictionary definitions, encyclopedia references, and the like) for use by the knowledge manager 104. Content users may access the knowledge manager 104 via a connection or an Internet connection to the network 180, and may input questions to the knowledge manager 104 that may be answered by the content in the corpus of data.

As further described below, when a process evaluates a given section of a document for semantic content, the process can use a variety of conventions to query it from the knowledge manager. One convention is to send a well-formed question 1. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions 1 (e.g., natural language questions, etc.) to the knowledge manager 104. Knowledge manager 104 may interpret the question and provide a response to the content user containing one or more answers 2 to the question 1. In some embodiments, the knowledge manager 104 may provide a response to users in a ranked list of answers 2.

In some illustrative embodiments, QA system 101 may be the IBM Watson™ QA system available from International Business Machines Corporation of Armonk, N.Y., which is augmented with the mechanisms of the illustrative embodiments described hereafter. The IBM Watson™ knowledge manager system may receive an input question 1 which it then parses to extract the major features of the question, that in turn are then used to formulate queries that are applied to the corpus of data stored in the knowledge base 106. Based on the application of the queries to the corpus of data, a set of hypotheses, or candidate answers to the input question, are generated by looking across the corpus of data for portions of the corpus of data that have some potential for containing a valuable response to the input question.

In particular, a received question 1 may be processed by the IBM Watson™ QA system 101 which performs deep analysis on the language of the input question 1 and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e., candidate answer, is inferred by the question. This process may be repeated for each of the candidate answers until the IBM Watson™ QA system identifies candidate answers that surface as being significantly stronger than others and thus, generates a final answer, or ranked set of answers, for the input question. The QA system 101 then generates an output response or answer 2 with the final answer and associated confidence and supporting evidence. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

In addition to providing answers to questions, QA system 101 is connected to at least a first computing system 14 having a connected display 12 and memory or database storage 20 for retrieving ground truth data 102 which is processed at the ground truth verification engine 16 to identify at least one machine annotated training set instance that belongs to a frequently misclassified training set cluster and that should be reviewed by human SME for verification purposes. To this end, the ground truth verification engine 16 includes a first classifier or annotator 17 (e.g., a true positive (TP) classifier) for generating annotated ground truth 21, such as annotated training set instances (e.g., entities and relationships), which is stored in the memory/database storage 20. The annotated ground truth may be converted by the vector processor 19 into feature vectors which are clustered and stored as cluster feature vectors 23. The ground truth verification engine 16 also uses a confusion matrix 22 to identify clusters of annotated training sets in the annotated ground truth 21 that are commonly confused or misclassified with one another so that selected misclassification features thereof can be used to train a second classifier or annotator 18 (e.g., a false positive (FP) classifier) to identify potentially misclassified training set instances (e.g., entities and relationships) which the vector processor 19 converts to vectors for storage as misclassified feature vectors 24. Using the confusion matrix 22, the ground truth verification engine 16 may also identify, in the annotated ground truth 21, a “true positive” training set instance that is paired with a corresponding “false positive” training set instance and that is presented as a reclassification recommendation to the human SME for use in prioritizing SME verification and correction to generate verified ground truth 103 which may be stored in the knowledge database 106 as verified GT 109B for use in training the QA system 101. Though shown as being directly connected to the QA system 101, the first computing system 14 may be indirectly connected to the QA system 101 via the computer network 180. Alternatively, the functionality described herein with reference to the first computing system 14 may be embodied in or integrated with the QA system 101.

In various embodiments, the QA system 101 is implemented to receive a variety of data from various computing devices (e.g., 110, 120, 130. 140, 150, 160, 170) and/or other data sources, which in turn is used to perform QA operations described in greater detail herein. In certain embodiments, the QA system 101 may receive a first set of information from a first computing device (e.g., laptop computer 130) which is used to perform QA processing operations resulting in the generation of a second set of data, which in turn is provided to a second computing device (e.g., server 160). In response, the second computing device may process the second set of data to generate a third set of data, which is then provided back to the QA system 101. In turn, the QA system 101 may perform additional QA processing operations on the third set of data to generate a fourth set of data, which is then provided to the first computing device (e.g., 130). In various embodiments the exchange of data between various computing devices (e.g., 101, 110, 120, 130, 140, 150, 160, 170) results in more efficient processing of data as each of the computing devices can be optimized for the types of data it processes. Likewise, the most appropriate data for a particular purpose can be sourced from the most suitable computing device (e.g., 110, 120, 130, 140. 150, 160, 170) or data source, thereby increasing processing efficiency. Skilled practitioners of the art will realize that many such embodiments are possible and that the foregoing is not intended to limit the spirit, scope or intent of the invention.

To train the QA system 101, the first computing system 14 may be configured to collect, generate, and store machine-annotated ground truth data 21 (e.g., as training sets and/or validation sets) having annotation instances which are clustered by feature similarity into cluster feature vectors 23 for storage in the memory/database storage 20. To efficiently collect the machine-annotated ground truth data 21, the first computing system 14 may be configured to access and retrieve ground truth data 109A that is stored at the knowledge database 106. In addition or in the alternative, the first computing system 14 may be configured to access one or more websites using search engine functionality or other network navigation tool to access one or more remote websites over the network 180 in order to locate information (e.g., an answer to a question). In selected embodiments, the search engine functionality or other network navigation tool may be embodied as part of a ground truth verification engine 16 which exchanges webpage data 11 using any desired Internet transfer protocols for accessing and retrieving webpage data, such as HTTP or the like. At an accessed website, the user may identify around truth data that should be collected for addition to a specified corpus, such as an answer to a pending question, or a document (or document link) that should be added to the corpus.

Once retrieved, portions of the ground truth 102 may be identified and processed by the first classifier or annotator 17 (e.g., a true positive (TP) classifier) to generate machine-annotated ground truth 21. To this end, the ground truth verification engine 16 may be configured with a machine annotator 17, such as dictionary or rule-based annotator or a machine-learned annotator front a small human-curated training set, which uses one or more knowledge resources to classify the document text passages from the retrieved ground truth to identify entity and relationship annotations in one or more training sets and validation sets. Once the machine-annotated training and validation sets are available (or retrieved from storage 20), the vector processor 19 may scan the annotated ground truth to generate a vector representation for each machine-annotated training set using any suitable vector formation tool (e.g., an extended version of Word2Vec, Doc2Vec, or similar tools) to convert phrases to vectors, and applying a cluster modeling program to cluster the vectors from the training set. To this end, the ground truth verification engine 16 may be configured with a suitable neural network model (not shown) which the vector processor 19 uses to generate feature vector representations of the phrases in the machine-annotated ground truth 21 and to cluster the feature vectors with a cluster modeling program (not shown) to output feature vector clusters as groups of phrases with similar meanings, effectively placing words and phrases with similar meanings close to each other (e.g., in a Euclidean space).

To identify portions of the machine-annotated ground truth 21 that would likely benefit from human verification to boost error detection, the ground truth verification engine 16 is configured to evaluate a confusion matrix 22 to identify clusters of machine-annotated training sets with high misclassification rates, such as clusters of annotated training sets that are oftentimes confused with one another and therefore likely to have high error rates within the machine-annotated ground truth 21. This evaluation process at the ground truth verification engine 16 may employ feature selection algorithms (e.g., sparse coding) to learn or select features/characteristics of the misclassified training set examples identified from the confusion matrix 22. Using the selected features/characteristics, the ground truth verification engine 16 may be configured to train the second classifier/annotator 18 to detect misclassified entity/relation instances which are processed by the vector processor 19 to generate misclassified feature vectors. The ground truth verification engine 16 may also be configured to identify one or more clusters as cluster reclassification recommendations in which the misclassified feature vectors should have been classified (e.g., true positive clusters) for SME verification.

To visually present cluster reclassification recommendations for SME review, the ground truth verification engine 16 is configured to display a ground truth (GT) interface 13 on the connected display 12. At the GT interface 13, the user at the first computing system 14 can manipulate a cursor or otherwise interact with a displayed listing of clustered entity/relation phrases that are prioritized and flagged for SME validation to verify or correct prioritized training examples in clusters needing human verification. In addition to a displayed cluster of entity/relation phrases, the GT interface 13 may also display cluster reclassification recommendations for each displayed cluster when its corresponding cluster feature vector 23 aligns with a misclassified feature vector 24 derived from the cluster matrix so that one or more cluster reclassification recommendations are displayed for the constituent entity/relation phrases from the cluster being displayed for SME review. Verification or correction information assembled in the ground truth interface window 13 based on input from the domain expert or system knowledge expert may be used to store and/or send verified ground truth data 103 for storage in the knowledge database 106 as stored ground truth data 109B for use in training a final classifier or annotator.

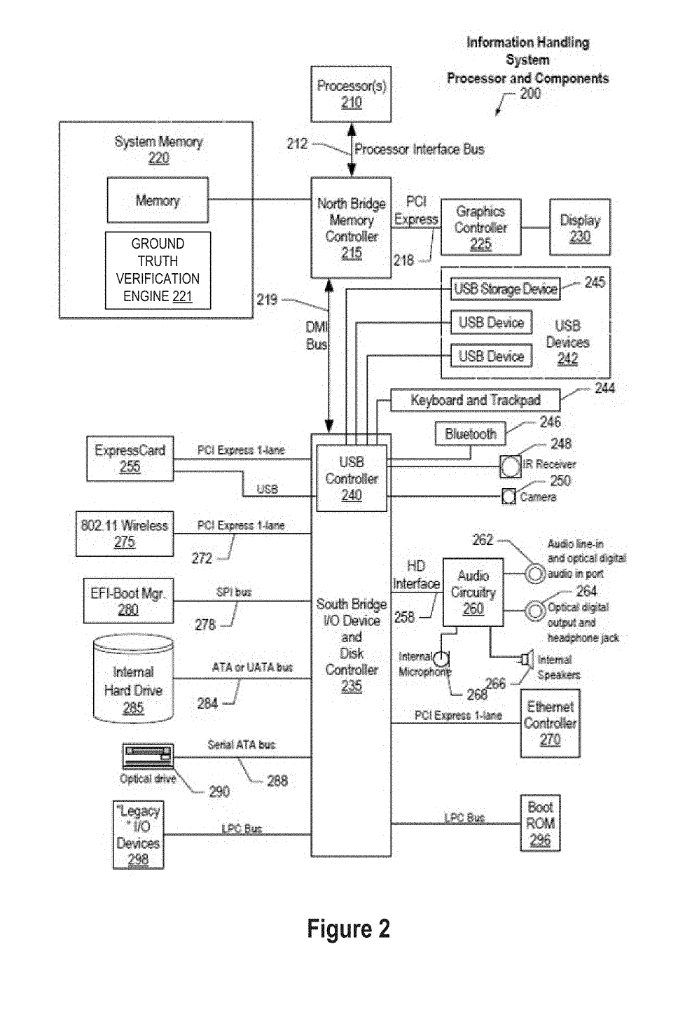

Types of information handling systems that can utilize QA system 101 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, server 160, and mainframe computer 170. As shown, the various information handling systems can be networked together using computer network 180. Types of computer network 180 that can be used to interconnect the various information handling systems include Personal Area Networks (PANS), Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores. For example, server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. In the system memory 220, a variety of programs may be stored in one or more memory devices, including a ground truth verification engine module 221 which may be invoked to process machine-annotated ground truth training set data using a confusion matrix to identify commonly confused entity/relationship instances and to interrogate therefrom candidate features for use in recognizing class sets of entity/relationship instances with high misclassification rates which are identified, prioritized, and highlighted as review candidates for a human annotator or SME to verify, either individually or in bulk, alone or in combination with evidence-based correction recommendations for the machine-annotated ground truth training set data, thereby boosting error detection and generating verified ground truth for use in training and evaluating a computing system (e.g., an IBM Watson™ QA system). Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219, in one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse. removable nonvolatile storage device 245, modems, network cards, ISDN connectors, fax, printers, USB hubs, and many other types of USB connected devices, While removable nonvolatile storage device 245 is shown as a USB-connected device, removable nonvolatile storage device 245 could be connected using a different interface, such as a Firewire interface, etc.

Wireless Local Area Network (LAN) device 275 connects to Southbridge 235 via the PCI or PCI Express bus 272. LAN device 275 typically implements one of the IEEE 802.11 standards for over-the-air modulation techniques to wireless communicate between information handling system 200 and another computer system or device. Extensible Firmware Interface (EFI) manager 280 connects to Southbridge 235 via Serial Peripheral interface (SPI) bus 278 and is used to interface between an operating system and platform firmware. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, an information handling system need not necessarily embody the north bridge/south bridge controller architecture, as it will be appreciated that other architectures may also be employed.

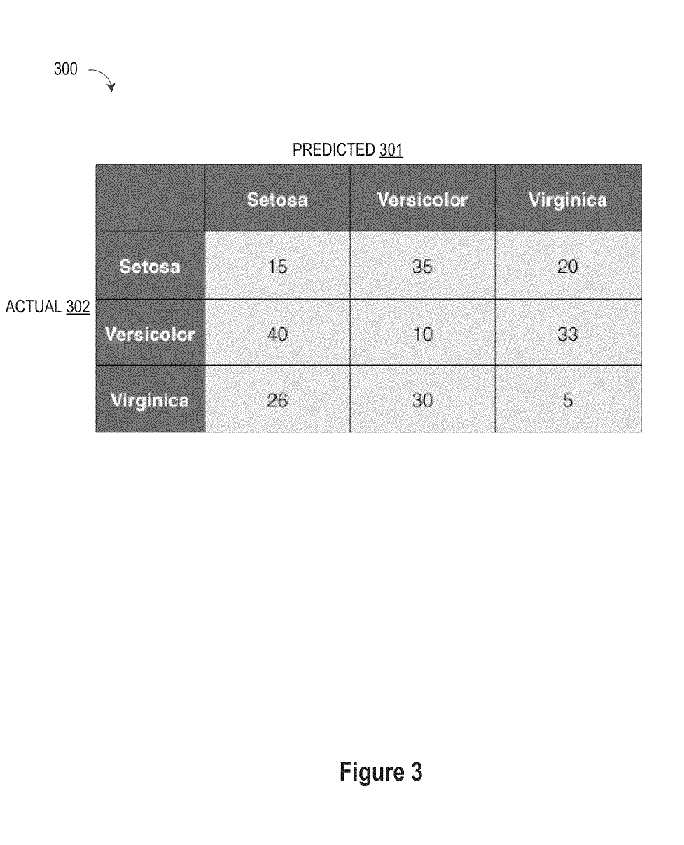

To illustrated further details of selected embodiments of the present disclosure, reference is now made to FIG. 3 which shows a simplified example of a data structure for a confusion matrix 300 in accordance with selected embodiments of the present disclosure. The confusion matrix data structure 300 can be used to assess the performance of a classifier by including columns for each of three example plant types (e.g., Setosa, Versicolor, and Virginica), and also including rows for each of the three example plant types. Specifically, each row represents an actual plant type, and each column represents a predicted plant type that can be confused with (i.e., incorrectly substituted for or even incorrectly transposed with) the correct or actual plant type. Therefore, each row and column combination indicates for a given pairing of plant types, the number of times the plant type represented by the column was confused with the plant type represented by the row thereby causing a misclassification. As will be appreciated, all off-diagonal elements on the confusion matrix data structure 300 represent misclassified data so that a. good classifier will yield a confusion matrix that will look dominantly diagonal. However, in the example confusion matrix data structure 300, the “Setosa” plant type was correctly classified 15 times by the classifier (e.g., a “true positive”), but was confused or misclassified 35 times with the plant type “Versicolor” (e.g., a “false positive”), and was confused or misclassified 20 times with the plant type “Virginica” (e.g., a “false positive”). In similar fashion, the example confusion matrix data structure 300 shows that the “Versicolor” plant type was correctly classified 10 times by the classifier (e.g., a “true positive”), but was confused or misclassified 40 times with the plant type “Setosa” (e.g., a “false positive”), and was confused or misclassified 33 times with the plant type “Virginica” (e.g., a “false positive”). Finally, the example confusion matrix data structure 300 shows that the “Virginica” plant type was correctly classified 5 times by the classifier (e.g., a “true positive”), but was confused or misclassified 26 times with the plant type “Setosa” (e.g., a “false positive”), and was confused or misclassified 30 times with the plant type “Versicolor” (e.g., a “false positive”).

Accordingly, based on the given sample size of plant type classification results, the confusion matrix data structure 300 indicates the “Setosa” plant type was correctly predicted 15 times out of 70 instances so as to be confused with the “Versicolor” instance 35 times out of a total of 70 instances (i.e., confused approximately 50% of the time) and to be confused with the “Virginica” instance 20 times out of a total of 70 instances (i.e., confused approximately 28.6% of the time). In addition, the “Versicolor” plant type was correctly predicted 10 times out of 83 instances so as to be confused with the “Setosa” instance 40 times out of a total of 83 instances (i.e., confused approximately 48.2% of the time) and to be confused with the “Virginica” instance 33 times out of a total of 83 instances (i.e., confused approximately 39.7% of the time). Likewise, the “Virginica” plant type was correctly predicted 5 times out of 61 instances so as to be confused with the “Setosa” instance 26 times out of a total of 61instances(i.e., confused approximately 42.6% of the time) and to be confused with the “Versicolor” instance 30 times out of a total of 61 instances (i e confused approximately 49.2% of the time).

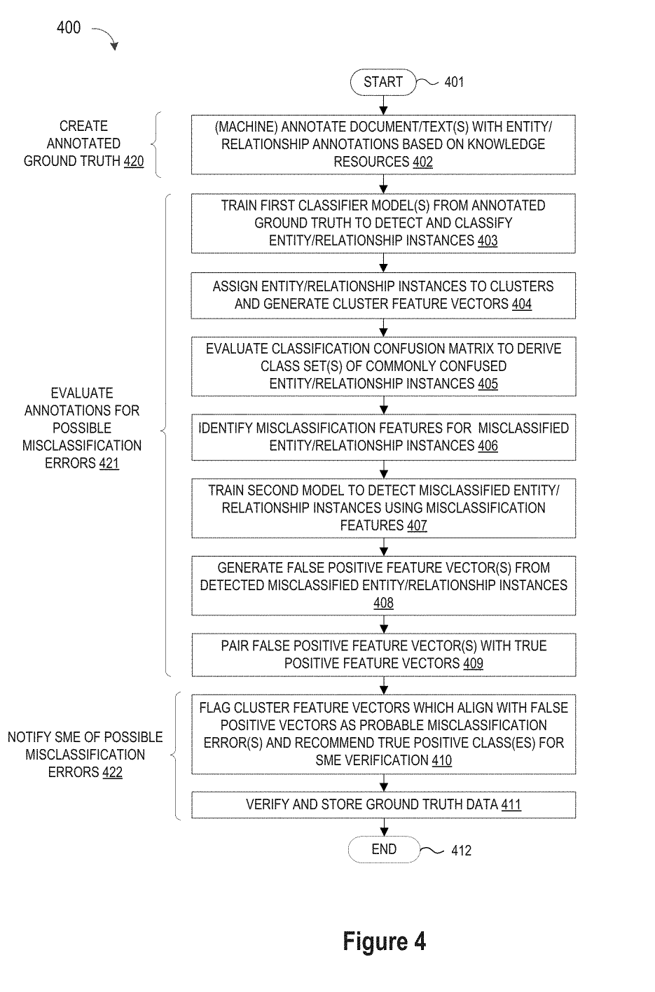

FIG. 4 depicts an approach that can be executed on an information handling system to verify and/or correct often-confused entity/relationship instances in clusters of machine-annotated ground truth data for use in training an annotator in a QA system, such as QA system 101 shown in FIG. 1. This approach can be implemented at the computing system 14 or the QA system 101 shown in FIG. 1, or may be implemented as a separate computing system, method, or module. Wherever implemented, the disclosed ground truth verification scheme efficiently clusters entity/relationship instances from a machine-annotated ground truth for batch verification to maximize the use of SME time by prioritizing clusters with high misclassification rates by using confusion matrices to identify candidate features from commonly confused examples to further hone the accuracy in flagging clusters for human verification using a browser-based ground truth verification interface window to efficiently verify, add or remove, either individually or in bulk (e.g., by cluster). The ground truth verification processing may include displaying a browser interface which provides a cluster view of entity and/or relationship mentions from the machine-annotated training and validations sets along with displayed verification suggestions for a user, such as a subject matter expert, so that each displayed cluster of entity/relationship mentions may include one or more evidence-based reclassification recommendations which are derived from the confusion matrix to enhance suspected error detection and boost correction of often-confused class predictions. By presenting clustered verification suggestions, the user can quickly and efficiently identify training examples that are very likely false positives or negatives. With the disclosed ground truth verification scheme, an information handling system can be configured to collect and verify ground truth data in the form of QA pairs and associated source passages for use in training the QA system.

To provide additional details for an improved understanding of selected embodiments of the present disclosure, reference is now made to FIG. 4 which depicts a simplified flow chart 400 showing the logic for facilitating verification of often-confused entity/relationship instances in clusters of machine-annotated ground truth data for use in training an annotator used by a QA system. The processing shown in FIG. 4 may be performed by a cognitive system, such as the first computing system 14, QA system 101, or other natural language question answering system. Wherever implemented, the disclosed ground truth verification scheme uses confusion matrix data to identify often-confused entity/relationship instances in machine-annotated ground truth training set which may be clustered and prioritized as review candidates for a human annotator or SME to verify, either individually or in bulk, alone or in combination with reclassification recommendations derived from the confusion matrix data.

FIG. 4 processing commences at 401 whereupon, at step 420, machine-annotated ground truth, such as annotated training sets and validations sets, are created using a human and/or machine annotator with at least a preliminary verification or correction by a human SME. In selected embodiments, the processing at step 420 may start with an annotation process (at step 402) wherein an initial human-curated training set is identified from a small batch of ground truth for use in training one or more seed models. For example, this seed model can be sourced from the ground truth that is curated from SMEs while drafting the ground truth guidelines. The identified initial training set and validation set may then be run through a machine annotator which parses the input text sentences to find entity parts of speech and their associated relationship instances in the sentence. To assist with the machine annotation at step 402, one or more knowledge resources may be retrieved, such as ontologies, semantic networks, or other types of knowledge bases that are generic or specific to a particular domain of the received document or the corpus from which the document was received. In addition, it will be appreciated that any suitable machine-annotator could be employed at step 402, such as dictionary-based machine-annotator, rule-based machine-annotator, and machine learning annotator, or the like. In addition or in the alternative, the processing at step 402 may include annotation of the initial training and validation sets with entity and relationship annotations based on the information contained in the knowledge resources. In addition, the machine-annotated validation set may be reviewed by a human SME to verify or correct any mistakes in the machine-annotated validation set to confirm that they are labeled correctly.

As will be appreciated, the initial creation of the machine-annotated training and validation sets at step 420 may be performed at a computing system, such as the QA system 101, first computing system 14, or other NLP question answering system having a ground truth verification engine 16 which uses a first classifier 17, such as a dictionary or rule-based annotator or other suitable named entity recognition classifier, to annotate the training sets and form therefrom annotated ground truth 21 (at step 402 As will be appreciated, the first classifier 17 may implement a machine annotation process on a given input sentence statement to locate and classify named entities in the training set text into pre-defined categories, such as the names of persons, organizations, locations, expressions of times, quantities, monetary values, percentages, etc. As described herein, a Natural Language Processing (NLP) routine may be used to parse the input sentence and/or identify potential named entities and relationship patterns, where “NLP” refers to the field of computer science, artificial intelligence, and linguistics concerned with the interactions between computers and human (natural) languages. In this context, NLP is related to the area of human-computer interaction and natural language understanding by computer systems that enable computer systems to derive meaning from human or natural language input.

At step 421, the ground truth verification method proceeds to apply machine analysis to evaluate the annotated ground truth 21 for possible misclassification errors. The processing at step 421 may be performed at a cognitive system, such as the QA system 101, first computing system 14, or other NLP question answering system having a ground truth verification engine 16 which uses a confusion matrix (e.g., 22) and vector processor (e.g., 19) to assign training set entity,/relationship annotations from the annotated ground truth 21 into clusters and to identify and prioritize clusters of candidate training example review candidates which include likely misclassified training set entity/relationship annotations for SME verification review.

In selected embodiments, the evaluation of the training set annotations at step 421 may begin with an initial classifier training step 403 wherein a first classifier model is trained from annotated ground truth to detect and classify entity/relationship instances therein. In selected embodiments, the training of the first classifier model at step 403 may be performed at a cognitive system, such as the QA system 101, first computing system 14, or other NLP question answering system, such as by training the first classifier or annotator 17 (e.g., a true positive (TP) classifier) from machine or human annotated ground truth 21, such as annotated training set instances (e.g., entities and relationships), which is stored in the memory/database storage 20. In selected embodiments, the processing at step 403 may employ feature selection algorithms as part of the machine analysis to train a model from the machine annotated entity/relationship instances. In selected embodiments, the analysis of the machine-annotated training sets may involve scanning the machine-annotated entity/relationship phrases to generate a vector representation for each machine-annotated training and validation set using any suitable technique, such as an extended version of Word2Vec, Doc2Vec, or similar tools, to convert phrases to vectors. In addition, the feature selection algorithms used at step 403 may be implemented to determine which features are most indicative of a “true positive” for an entity or relationship and to appropriately weigh such features.

At step 404, the vector representations of the machine-annotated training and validation sets are assigned to clusters based on feature similarity, such as by using a rule-based probabilistic algorithm or other suitable clustering technique for grouping machine-annotated entity/relationship instances into class sets. In selected embodiments, the cluster processing at step 404 may be performed at a cognitive system, such as the QA system 101, first computing system 14, or other NLP question answering system, which uses a vector processor (e.g., 19) to apply a cluster model to perform sentence-level or text clustering. In an example embodiment, the cluster processing step 404 may employ k-means clustering to use vector quantization for cluster analysis of the machine-annotated entity/relationship instances. As a result of whatever clustering technique is used, one or more cluster feature vectors 23 are generated from the clustered entity or relationship instances and stored in the memory 20.

At step 405, the classification confusion matrix is evaluated to derive one or more class sets of commonly confused entity/relationship instances. In selected embodiments, the confusion matrix evaluation processing at step 405 may be performed at a cognitive system, such as the QA system 101, first computing system 14, or other NLP question answering system, which uses a vector processor (e.g., 19) to access a confusion matrix (e.g., 22) to identify class sets or groups of entity/relationship instances that are commonly confused or misclassified with one another. Classes with high misclassification rates, especially class sets that are oftentimes confused with one another, are likely to have high error rates within the machine-annotated ground truth.

Once the commonly confused or misclassified class sets are identified, misclassification features are identified for the misclassified entity/relationship instances at step 406. The processing to identify misclassification features may be performed at a cognitive system, such as the QA system 101, first computing system 14, or other NLP question answering system, which employs feature selection algorithms (e.g., sparse coding) on the misclassified entity/relationship instances to learn common features/characteristics of the misclassified examples that can be used to detect suspected misclassification errors on the clusters of entity/relation instances.

After identifying the features/characteristics of the misclassified examples, a second classifier training step 407 is performed to train a second classifier model to detect and classify misclassified entity/relationship instances in the annotated ground truth training set. In selected embodiments, the training of the second classifier model at step 407 may be performed at a cognitive system, such as the QA system 101, first computing system 14, or other NLP question answering system, which is configured to train the second classifier or annotator 18 (e.g., a false positive (FP) classifier) from machine or human annotated ground truth 21, such as annotated training set instances (e.g., entities and relationships) stored in the memory/database storage 20. In selected embodiments, the processing at step 407 may employ machine analysis to train the second model from the machine annotated entity/relationship instances by scanning the machine-annotated entity/relationship phrases using the identified misclassification features to identify misclassified machine-annotated training set instances.

At step 408, misclassification feature vectors are generated from the identified misclassified machine-annotated training set instances. In selected embodiments, the processing at step 408 may be performed at a cognitive system, such as the QA system 101, first computing system 14, or other NLP question answering system, which is configured to use machine analysis to generate a vector representation for each misclassified machine-annotated training set, such as by using any suitable technique to convert phrases to vectors. As a result, one or more “false positive” feature vectors 24 are generated from the misclassified entity or relationship instances and stored in the memory 20.

Once false positive feature vectors are identified, they may be paired with true positive feature vectors at step 409. In selected embodiments, the processing at step 409 may be performed at a cognitive system, such as the QA system 101, first computing system 14, or other NLP question answering system, which uses the confusion matrix (e.g., 22) to pair misclassification feature vectors from misclassified examples to the class in which they should have been classified (true positive). By linking a corresponding true positive for each misclassification example to each corresponding misclassification feature vector, classification corrections can be recommended for each suspected misclassification error flagged for human SME verification during verification of the annotated ground truth. The pairing or linking may be defined in the entity typename (e.g., sentosa_veriscolor) to indicate that the true positive for the plant type “Sentosa” is “Verisicolor.”

At step 422, the ground truth verification method provides a notification to the human SME of prioritized clusters with possible misclassification errors in the candidate erroneous training examples identified at step 421. The processing at step 422 may be performed at a cognitive system, such as the QA system 101, first computing system 14, or other NLP question answering system having a ground truth (GT) interface (e.g., 13) that is configured to display clustered training examples that are flagged for SME validation on the basis of the corresponding machine-annotated cluster feature vectors being aligned with false positive vectors for the likely misclassified entity/relationship instances. In effect, the first classifier model (from step 403) is run to identify annotated entity/relationship instances from the training set, and the second classifier model (from step 407) is run to identify misclassified annotated entity/relationship instances from the training set so that, if there are no misclassified annotated entity/relationship instances identified from the second classifier model, then the results of the first classifier model are treated as “true positives.” However, if there are misclassified annotated entity/relationship instances identified from the second classifier model, then these are “false positives” which are possible misclassifications that should be resolved by the SME verification process.

The alignment of the cluster feature vectors and false positive or misclassification vectors may be determined on the basis of high cosine similarity or other suitable vector alignment technique. In selected embodiments, the notification processing at step 422 may begin at step 410 by visually presenting one or more training example clusters as probable misclassification errors that are flagged for SME review, alone or in combination with one or more recommended true positive classes for SME consideration as possible reclassifications for the possible misclassification errors. The visual presentation of the training example clusters may flag candidate erroneous training examples within a cluster for possible reclassification by providing a cluster view of entity and/or relationship mentions from the training sets, where each cluster is prioritized for display on the basis of containing suspected misclassification errors that are identified from the cluster matrix. In addition, the visual presentation of the training example clusters may include verification suggestions for the human SME to identify training examples most likely to be misclassified or mislabeled, grouped by cluster, so that the human SME can quickly and efficiently identify training examples that are very likely false positives or negatives. The displayed verification suggestions may include verification options for editing selected instances, removing selected instances, removing an entire cluster, and/or leaving the training set unchanged.

At step 411, the ground truth verification method updates and retrains the model based on the SME verification or correction input. The processing at step 411 may be performed at a cognitive system, such as the QA system 101, first computing system 14, or other NLP question answering system, which may iteratively repeat the steps 402-411 until detecting that the verification process is done. For example, the SME-evaluated training set can be used as ground truth data to train QA systems, such as by presenting the ground truth data in the form of question-answer-passage (QAP) triplets or answer keys to a machine learning algorithm. Alternatively, the ground truth data can be used for blind testing by dividing the ground truth data into separate sets of questions and answers so that a first set of questions and answers is used to train a machine learning model by presenting the questions from the first set to the QA system, and then comparing the resulting answers to the answers from a second set of questions and answers.

After using the ground truth collection process 400 to identify, collect, and evaluate ground truth data, the process ends at step 412 until such time as the user reactivates the ground truth verification process 400 with another session. Alternatively, the ground truth verification process 400 may be reactivated by the QA system which monitors source documents to detect when updates are available. For example, when a new document version is available, the QA system may provide setup data to the ground truth collector engine 16 to prompt the user to re-validate the document for re-ingestion into the corpus if needed.

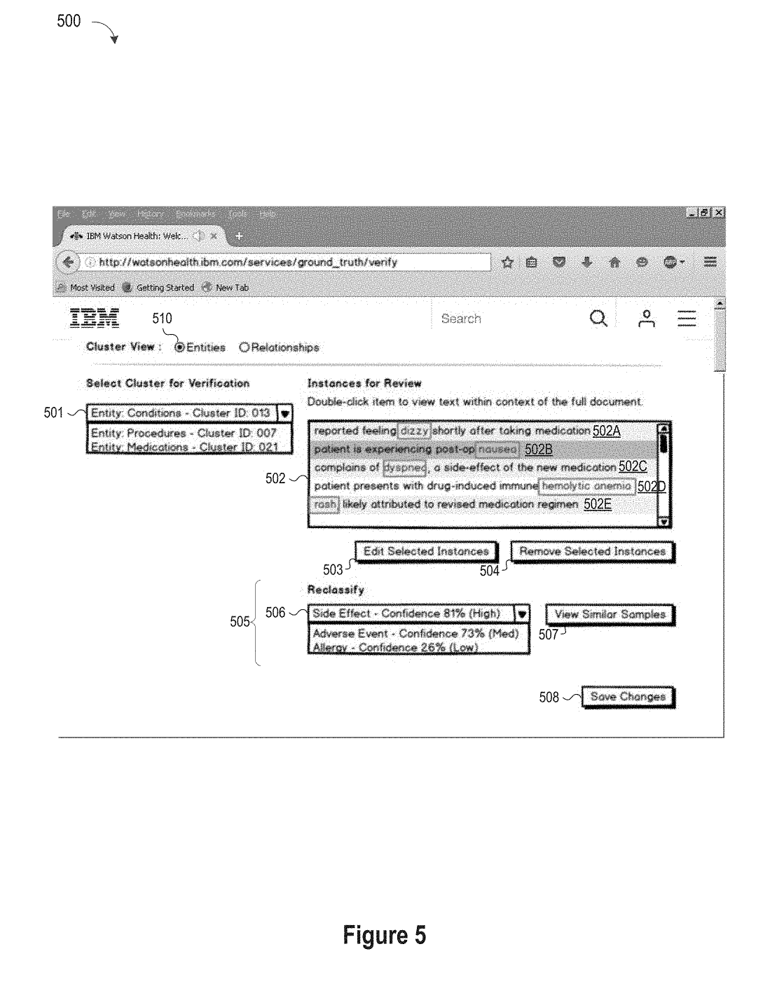

To illustrate additional details of selected embodiments of the present disclosure, reference is now made to FIG. 5 which illustrates an example ground truth verification interface display screen shot 500 with a clustered view of entity and/or relationship mentions 502 from machine-annotated training sets for a selected cluster 501 used in connection with a browser-based ground truth data verification sequence. As indicated with the screen shot 500, a user may access ground truth verification service (http://watsonhealth.ibm.com/services/ground_truth/verify) which displays information that may be used to create an annotator component by training the machine-learning annotator and evaluating how well the annotator performed when annotating test data and blind data. In response to the user selecting or ticking the “Entities” option button 510, the depicted screen shot 500 shows that the user is processing a first entity cluster 501 (e.g., “Entity: Conditions—Cluster ID: 013”) that may be selected from a drop-down menu of clusters. As will be appreciated, a cluster view of relationship mentions may be displayed in response to the user selecting or ticking the “Relationships” option button. With each selected cluster, the screen shot 500 may also display a cluster view of the cluster's entity mentions 502A-E. Instead of displaying a flat list of entity/relationship mention instances for human verification, the background processing for the verification interface display screen 500 clusters similar entity/relationship mention instances and sorts the clusters based on expected cluster Misclassification rate due to the presence of commonly confused classifications.

To organize the visual presentation of machine-annotated ground truth data for efficient verification, the verification interface display screen shot 500 may be configured to provide a clustered view of entity and/or relationship mentions by using an “Entity Cluster” viewing window or area 501 and an “Entity Instances” viewing window or area 502. Under the “Entity Cluster” viewing window/area 501, a. first prioritized entity cluster (e.g., “Entity: Conditions—Cluster ID: 013”) is displayed that was selected or flagged on the basis of desired ranking or scoring mechanism, such as a quantification of the likelihood that the cluster contains misclassified entity/relationship instances. In selected embodiments, the entity cluster field 501 may list a plurality of ranked entity clusters in a drop-down menu that are ranked by descending cluster rank or score. Under the “Entity Instances” viewing window/area 502, the entity instances 502A-E corresponding to the first prioritized entity cluster 501 are listed for review, correction and verification by the user. As disclosed herein, the entity instances 502A-E in each entity group (e.g., 501) may be generated using any suitable vector formation and clustering technique to represent each training/validation set phrase in vector form and then determine a similarity or grouping of different vectors, such as by using a neural network language model representation techniques (e.g., Word2Vec, Doc2Vec, or similar tool) to convert words and phrases to vectors which are then input to a clustering algorithm to place words and phrases with similar meanings close to each other in a Euclidean space.

Through user interaction with one or more control buttons 503-504, the user has the option to accept or reject the listed entity instances 502A-E for the first prioritized entity cluster 501. For example, the user can click on a suggestion to see the entire document (through cursor interaction with a selected training example), edit one or more selected instances (with button 503), and/or remove one or more selected instances (with button 504). In addition or in the alternative, the user can accept an entire cluster of entity instances, accept or verify individual entity instances, reject an entire cluster of entity instances, or reject individual entity instances.

In addition or in the alternative, the verification interface display screen 500 may be configured to make verification suggestions to a user by displaying a reclassification recommendation for at least one of the annotated training set instances in each entity/relationship cluster which aligns with a misclassified feature vector. To this end, a reclassification recommendation area 505 may include an entity reclassification field 506 which may list a plurality of ranked reclassification recommendations in a drop-down menu that are ranked by descending confidence rank or score. Under the entity reclassification field 506, a first reclassification recommendation (e.g., “Side Effect”) and associated confidence measure (e.g., “Confidence 81%”) are displayed for a selected annotation entity instance (e.g., “nausea” in entity instance 502B). The entity reclassification field 506 may also include a sorted list of alternative reclassification recommendations (e.g., “Adverse Event—Confidence 73%” and “Allergy—Confidence 26%”) that are listed for review, selection, and verification by the user. Once the entity instances 502A-E for the review candidate training examples in the “Entity Instances” viewing window/area 502 are corrected, reclassified, or verified by the SME, the training set is updated to retrain the classifier or annotator model, and the ground truth data verification sequence is iteratively repeated until an evaluation of the training set annotations indicates that the required accuracy is obtained.

By now, it will be appreciated that there is disclosed herein a system, method, apparatus, and computer program product for classifying elements in a ground truth training set at an information handling system having a processor and a memory. In selected embodiments, each element being classified is an entity/relationship element. As disclosed, the system, method, apparatus, and computer program perform annotation operations on a ground truth training set using an annotator, such as a dictionary annotator, rule-based annotator, or a machine learning annotator, to generate a machine-annotated training set. Subsequently, elements from the machine-annotated training set are assigned to one or more clusters, such as by generating a vector representation for each element from the machine-annotated training set, and then grouping the vector representations for the elements from the machine-annotated training set elements into one or more clusters, such as by applying one or more feature selection algorithms to the vector representations of the machine-annotated training set examples to identify the one or more clusters. The information handling system may then use a natural language processing (NLP) computer system to analyze one or more of the clusters to identify at least a first prioritized cluster containing one or more elements which are frequently misclassified. In selected embodiments, analysis of the one or more clusters includes identifying a group of elements from a confusion matrix that are commonly confused with one another. Such cluster analysis may be implemented by applying one or more feature selection algorithms to the group of elements from the confusion matrix that are commonly confused with one another to identify error characteristics of each misclassified element, and then generating a vector representation for each misclassified element from the error characteristics of each misclassified element. In addition, the cluster analysis may include detecting an alignment between a vector representation for each misclassified element and a vector representation of the one or more clusters. To solicit verification or correction feedback from a human subject matter expert (SME) for inclusion in an accepted training set, the information handling system may display machine-annotated training set elements associated with the first prioritized cluster along with a warning that the first prioritized cluster contains one or more elements which are frequently misclassified. In selected embodiments, the information handling system may also display a reclassification recommendation for a correct classification for at least one of the one or more elements which are frequently misclassified, where each reclassification recommendation is paired with a corresponding element which is frequently misclassified based on information derived from a confusion matrix. In other embodiments, the classifications for all machine-annotated training set elements in a cluster may be verified or corrected individually or in a single group based on verification or correction feedback from the human subject matter expert. Through an iterative process of repeating the foregoing steps, the accepted training set may be used to train a final annotator.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of classifying elements in a ground truth training set, the method comprising:
performing, by the information handling system, comprising a processor and a memory, annotation operations on a ground truth training set using an annotator to generate a machine-annotated training set;
assigning, by the information handling system, elements from the machine-annotated training set to one or more clusters;
analyzing, by the information handling system, the one or more clusters to identify at least a first prioritized cluster containing one or more elements which are frequently misclassified; and
displaying, by the information handling system, machine-annotated training set elements associated with the first prioritized cluster along with a warning that the first prioritized cluster contains one or more elements which are frequently misclassified to solicit verification or correction feedback from a human subject matter expert (SME) for inclusion in an accepted training set.

2. The method of claim 1, where the annotator comprises a dictionary annotator, rule-based annotator, or a machine learning annotator.

3. The method of claim 1, where assigning elements from the machine-annotated training set to one or more clusters comprises:
generating a vector representation for each element from the machine-annotated training set; and
grouping the vector representations for the elements from the machine-annotated training set elements into one or more clusters.

4. The method of claim 1, where analyzing the one or more clusters comprises identifying a group of elements from a confusion matrix that are commonly confused with one another.

5. The method of claim 4, where analyzing the one or more clusters comprises:
applying one or more feature selection algorithms to the group of elements from the confusion matrix that are commonly confused with one another to identify error characteristics of each misclassified element; and
generating a vector representation for each misclassified element from the error characteristics of each misclassified element.

6. The method of claim 5, where analyzing the one or more clusters comprises detecting an alignment between a vector representation for each misclassified element and a vector representation of the one or more clusters.

7. The method of claim 1, further comprising displaying a reclassification recommendation for a correct classification for at least one of the one or more elements which are frequently misclassified.

8. The method of claim 7, where each reclassification recommendation is paired with a corresponding element which is frequently misclassified based on information derived from a confusion matrix.

9. The method of claim 1, further comprising verifying or correcting classifications for all machine-annotated training set elements in a cluster as a single group based on verification or correction feedback from the human subject matter expert.

10. The method of claim 1, where each element is an entity/relationship element.

11. A computer program product comprising a computer readable storage medium having a computer readable program stored therein, wherein the computer readable program, when executed on an information handling system, causes the system to classify elements in a ground truth training set by:
performing annotation operations on a ground truth training set using an annotator to generate a machine-annotated training set;
assigning elements from the machine-annotated training set to one or more clusters;
analyzing the one or more clusters to identify at least a first prioritized cluster containing one or more elements which are frequently misclassified; and
displaying machine-annotated training set elements associated with the first prioritized cluster along with a warning that the first prioritized cluster contains one or more elements which are frequently misclassified to solicit verification or correction feedback from a human subject matter expert (SME) for inclusion in an accepted training set.

12. The computer program product of claim 10, wherein the computer readable program, when executed on the system, causes the system to assign elements from the machine-annotated training set to one or more clusters by:
generating a vector representation for each element from the machine-annotated training set; and
grouping the vector representations for the elements from the machine-annotated training set elements into one or more clusters.

13. The computer program product of claim 10, wherein the computer readable program, when executed on the system, causes the system to analyze the one or more clusters by identifying a group of elements from a confusion matrix that are commonly confused with one another.

14. The computer program product of claim 13, wherein the computer readable program, when executed on the system, causes the system to analyze the one or more clusters by:
applying one or more feature selection algorithms to the group of elements from the confusion matrix that are commonly confused with one another to identify error characteristics of each misclassified element; and
generating a vector representation for each misclassified element from the error characteristics of each misclassified element.

15. The computer program product of claim 14, wherein the computer readable program, when executed on the system, causes the system to analyze the one or more clusters by detecting an alignment between a vector representation for each misclassified element and a vector representation of the one or more clusters.

16. The computer program product of claim 14, wherein the computer readable program, when executed on the system, causes the system to display a reclassification recommendation for a correct classification for at least one of the one or more elements which are frequently misclassified, where each reclassification recommendation is paired with a corresponding element Which is frequently misclassified based on information derived from a confusion matrix.

17. The computer program product of claim 10, further comprising computer readable program, when executed on the system, causes the system to verify or correct classifications for all machine-annotated training set elements in a cluster as a single group based on verification or correction feedback from the human subject matter expert.

18. An information handling system comprising:
one or more processors;
a memory coupled to at least one of the processors; and
a set of instructions stored in the memory and executed by at least one of the processors to classify elements in a ground truth training set, wherein the set of instructions are executable to perform actions of:
performing, by the system, annotation operations on a ground truth training set using an annotator to generate a machine-annotated training set;
assigning, by the system, elements from the machine-annotated training set to one or more clusters;
analyzing, by the system, the one or more clusters to identify at least a first prioritized cluster containing one or more elements which are frequently misclassified; and
displaying, by the system, machine-annotated training set elements associated with the first prioritized cluster along with a warning that the first prioritized cluster contains one or more elements which are frequently misclassified to solicit verification or correction feedback from a human subject matter expert (SME) for inclusion in an accepted training set.

19. The information handling system of claim 18, where analyzing the one or more clusters comprises identifying a group of elements from a confusion matrix that are commonly confused with one another.

20. The information handling system of claim 19, where analyzing the one or more clusters comprises:
applying one or more feature selection algorithms to the group of elements from the confusion matrix that are commonly confused with one another to identify error characteristics of each misclassified element; and
generating a vector representation for each misclassified element from the error characteristics of each misclassified element.

21. The information handling system of claim 20, where analyzing the one or more clusters comprises detecting an alignment between a vector representation for each misclassified element and a vector representation of the one or more clusters.

22. The information handling system of claim 18, further comprising displaying a reclassification recommendation for a correct classification for at least one of the one or more elements which are frequently misclassified, where each reclassification recommendation is paired with a corresponding element which is frequently misclassified based on information derived from a confusion matrix.

23. The information handling system of claim 18, further comprising verifying or correcting all classifications for all machine-annotated training set elements in a cluster as a single group based on verification or correction feedback from the human subject matter expert.

24. The information handling system of claim 18, further comprising verifying or correcting classifications for all machine-annotated training set elements in a cluster one at a time based on verification or correction feedback from the human subject matter expert.
